(19) United States
(12) Patent Application Publication
(10) Pub. No.: US 2009/0316840 A1
(43) Pub. Date: Dec. 24, 2009

(54) METHODS AND SYSTEMS FOR STC SIGNAL DECODING USING MIMO DECODER

(75) Inventors: Jong Hyeon Park, San Jose, CA (US); Brian Clark Banister, San Diego, CA (US); Inyup Kang, San Diego, CA (US); Je Woo Kim, Cupertino, CA (US); James Y. Hurt, San Diego, CA (US); Matthias Brehler, Boulder, CO (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/211,935

(22) Filed: Sep. 17, 2008

Related U.S. Application Data
(60) Provisional application No. 61/075,320, filed on Jun. 24, 2008.

(51) Int. Cl. H04L 27/06

(52) U.S. Cl. 375/341; 375/340

(57) ABSTRACT

Space time coding (STC) may be applied at the transmitter adding redundant information in both space and time dimensions. At the receiver, the received STC signal may be decoded using a spatial multiplexing MIMO decoding, for example, based on either Minimum Mean Square Error (MMSE) or maximum-likelihood (ML) algorithms. A selective STC decoder may incorporate both the conventional maximum ratio combining (MRC) decoding scheme and a MIMO decoding scheme. One of the STC decoding schemes may be selected, for example, based on estimated channel conditions in order to achieve a trade-off between error rate performance and computational complexity. Components used for a non-selected scheme may be powered down.

### PRIORITY APPLICATION

This application claims the benefit of priority from U.S. Provisional Patent Application Ser. No. 61/075,320, filed Jun. 24, 2008 and entitled “Methods and Systems for STC Signal Decoding using MIMO Decoder,” which is fully incorporated herein by reference for all purposes.

### TECHNICAL FIELD

The present disclosure generally relates to communication, and more specifically to methods and systems for space time signal decoding at a receiver in a MIMO wireless communication system.

### BACKGROUND

A multiple-input multiple-output (MIMO) communication system employs multiple (N_{T}) transmit antennas and multiple (N_{R}) receive antennas for data transmission. A MIMO channel formed by the N_{T} transmit and N_{R} receive antennas may be decomposed into N_{S} independent channels, with N_{S}≦min {N_{T}, N_{R}}. Each of the N_{S} independent channels is also referred to as a spatial sub-channel of the MIMO channel and corresponds to a dimension. The MIMO system can provide improved performance (e.g., increased transmission capacity) over that of a single-input single-output (SISO) communication system if the additional dimensionalities created by the multiple transmit and receive antennas are utilized.

A wideband MIMO system typically experiences frequency selective fading, meaning different amounts of attenuation across the system bandwidth. This frequency selective fading causes inter-symbol interference (ISI), which is a phenomenon whereby each symbol in a received signal acts as distortion to subsequent symbols in the received signal. This distortion degrades performance by impacting ability to correctly detect the received symbols. As such, ISI is a non-negligible noise component that may have a large impact on the overall signal-to-noise-and-interference ratio (SNR) for systems designed to operate at high SNR levels, such as MIMO systems. In such systems, equalization may be used at receivers to combat the ISI. However, the computational complexity required to perform equalization is typically significant or prohibitive for most applications.

Orthogonal frequency division multiplexing (OFDM) may be used to combat ISI without the use of computationally intensive equalization. An OFDM system effectively partitions the system bandwidth into a number of (N_{F}) frequency sub-channels, which may be referred to as sub-bands or frequency bins. Each frequency sub-channel is associated with a respective subcarrier frequency upon which data may be modulated. The frequency sub-channels of the OFDM system may experience frequency selective fading (i.e., different amounts of attenuation for different frequency sub-channels) depending on characteristics (e.g., multipath profile) of the propagation path between transmit and receive antennas. With OFDM, the ISI due to the frequency selective fading may be combated by repeating a portion of each OFDM symbol (i.e., appending a cyclic prefix to each OFDM symbol), as is known in the art. A MIMO system may thus advantageously employ OFDM to combat ISI.

In order to increase the transmission data rate and spectral efficiency of the system, spatial multiplexing may be applied at the transmitter where different and independent data streams may be communicated over a plurality of spatial sub-channels. In this case, detection accuracy of the receiver can be severely degraded due to a strong multiple access interference (interference of data streams transmitted from different antennas). Moreover, spatial and frequency sub-channels may experience different channel conditions (e.g., fading and multipath effects) and may achieve different SNRs. Also, channel conditions may vary over time.

The space time coding (STC) may be applied at the transmitter to improve error protection of the information signal communicated over wireless channels by adding redundancy in both spatial and temporal domains. At the receiver, the STC decoding may be performed along with outer MIMO channel decoding to reconstruct the transmitted signal. The STC signal decoder typically utilizes Maximum Ratio Combining (MRC) algorithm if spatial sub-channels are mutually orthogonal during the STC symbol duration. This is usually the case if mobility of users is low, and if low-order modulation types are applied at the transmitter. On the other side, the MRC decoding may suffer error rate performance degradation if spatial sub-channels are not mutually orthogonal.

Therefore, there is a need in the art for methods and systems to improve the STC signal decoding when mobility of users is high and if high-order modulation types are applied at the transmitter.

### SUMMARY

Certain embodiments of the present disclosure provide a method for decoding data transmitted in a wireless multi-channel communications system using a space time coding (STC) scheme. The method generally includes receiving STC signals transmitted over multiple channels utilizing an STC scheme, modeling the STC signals as if transmitted as spatially multiple-input multiple-output (MIMO) signals, and decoding the first sequence of received signals using a MIMO decoding scheme. The MIMO decoding scheme may include, for example, a Minimum Mean Square Error (MMSE) or a Maximum-Likelihood (ML) based decoding scheme.

Certain embodiments of the present disclosure provide a method for wireless communication. The method generally includes selecting between a multiple-input, multiple-output (MIMO) decoder and a maximum ratio combining (MRC) decoder for decoding a space-time coded (STC) signal, based at least on one or more parameters, and decoding the STC signal using the selected decoder.

Certain embodiments of the present disclosure provide an apparatus for decoding data transmitted in a wireless multi-channel communications system using a space time coding (STC) scheme. The apparatus generally includes logic for receiving STC signals transmitted over multiple channels utilizing an STC scheme, logic for modeling the STC signals as if transmitted as spatially multiple-input multiple-output (MIMO) signals, and logic for decoding the first sequence of received signals using a MIMO decoding scheme. The MIMO decoding scheme may include, for example, a Minimum Mean Square Error (MMSE) or a Maximum-Likelihood (ML) based decoding scheme.

Certain embodiments of the present disclosure provide an apparatus for wireless communication. The apparatus generally includes logic for selecting between a multiple-input, multiple-output (MIMO) decoder and a maximum ratio combining (MRC) decoder for decoding a space-time coded (STC) signal, based at least on one or more parameters, and decoding the STC signal using the selected decoder.

Certain embodiments of the present disclosure provide an apparatus for decoding data transmitted in a wireless multi-channel communications system using a space time coding (STC) scheme. The apparatus generally includes means for receiving STC signals transmitted over multiple channels utilizing an STC scheme, means for modeling the STC signals as if transmitted as spatially multiple-input multiple-output (MIMO) signals, and means for decoding the first sequence of received signals using a MIMO decoding scheme. The MIMO decoding scheme may include, for example, a Minimum Mean Square Error (MMSE) or a Maximum-Likelihood (ML) based decoding scheme.

Certain embodiments of the present disclosure provide an apparatus for wireless communication. The apparatus generally includes means for selecting between a multiple-input, multiple-output (MIMO) decoder and a maximum ratio combining (MRC) decoder for decoding a space-time coded (STC) signal, based at least on one or more parameters, and decoding the STC signal using the selected decoder.

Certain embodiments of the present disclosure generally include a computer-program product for decoding data transmitted in a wireless multi-channel communications system using a space time coding (STC) scheme, comprising a computer readable medium having instructions stored thereon, the instructions being executable by one or more processors. The instructions generally include instructions for receiving STC signals transmitted over multiple channels utilizing an STC scheme, modeling the STC signals as if transmitted as spatially multiple-input multiple-output (MIMO) signals, and decoding the first sequence of received signals using a MIMO decoding scheme. The MIMO decoding scheme may include, for example, a Minimum Mean Square Error (MMSE) or a Maximum-Likelihood (ML) based decoding scheme.

Certain embodiments of the present disclosure generally include a computer-program product for wireless communication, comprising a computer readable medium having instructions stored thereon, the instructions being executable by one or more processors. The instructions generally include instructions for selecting between a multiple-input, multiple-output (MIMO) decoder and a maximum ratio combining (MRC) decoder for decoding a space-time coded (STC) signal, based at least on one or more parameters, and decoding the STC signal using the selected decoder.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an exemplary wireless communication system in accordance with certain embodiments of the present disclosure.

FIG. 2 illustrates an exemplary wireless network environment in accordance with certain embodiments of the present disclosure.

FIG. 3 illustrates an exemplary MIMO OFDM system in accordance with certain embodiments of the present disclosure.

FIG. 4 illustrates a first exemplary STC system model in accordance with certain embodiments of the present disclosure.

FIG. 5 illustrates a second exemplary STC system model in accordance with certain embodiments of the present disclosure.

FIG. 6 illustrates an exemplary STC signal decoder using MRC in accordance with certain embodiments of the present disclosure.

FIG. 7 illustrates an exemplary STC signal decoder using MMSE in accordance with certain embodiments of the present disclosure.

FIG. 8 illustrates an exemplary implementation of Max-Log-MAP ML decoding in accordance with certain embodiments of the present disclosure.

FIG. 9 shows a process of selective STC decoding in accordance with certain embodiments of the present disclosure.

FIG. 9A illustrates example components capable of performing the operations illustrated in FIG. 9.

FIG. 10 illustrates an exemplary selective STC decoder in accordance with certain embodiments of the present disclosure.

FIG. 11 shows ML/MMSE performance gain in decibel (dB) units relative to the MRC based STC decoding at the packet error rate (PER) of 10⁻² in accordance with certain embodiments of the present disclosure.

### DETAILED DESCRIPTION

The present disclosure provides techniques to apply MIMO decoding schemes, such as ML and MMSE based MIMO decoding schemes, to decode STC signals. For certain embodiments, STC signals may be selectively decoded with either an MRC-based decoding algorithm or a MIMO-based algorithm. The decoding algorithm may be selected based on channel conditions, such as orthogonality of the channels.

The word “exemplary” is used herein to mean “serving as an example, instance, or illustration.” Any embodiment described herein as “exemplary” is not necessarily to be construed as preferred or advantageous over other embodiments.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

Certain disclosed embodiments may also be used with various antenna arrangements such as single-input single-output (SISO), single-input multiple-output (SIMO), multiple-input single-output (MISO), and multiple-input multiple-output (MIMO) transmissions. Single-input refers to one transmit antenna and multiple-input refers to multiple transmit antennas for data transmission. Single-output refers to one receive antenna and multiple-output refers to multiple receive antennas for data reception.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility and strong multipath immunity over conventional single carrier modulation schemes.

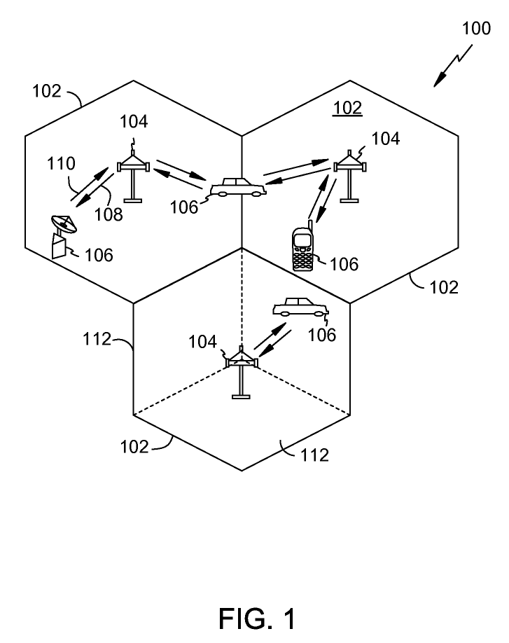

FIG. 1 illustrates an exemplary wireless communication system 100 in accordance with certain embodiments set forth herein. Wireless communication system 100 may be a broadband wireless communication system. The term “broadband wireless” refers to technology that at least provides wireless, audio, video, voice, Internet, and/or data network access. Wireless communication system 100 provides communication for one or more cells 102, each of which is serviced by a base station 104. Base station 104 may be a fixed station that communicates with user terminals 106 within cell 102 serviced by that base station 104. Base station 104 may alternatively be referred to as an access point, Node B or some other terminology.

As shown in FIG. 1, various user terminals 106 dispersed throughout wireless communication system 100. User terminals 106 may be fixed (i.e., stationary), mobile or capable of both. User terminals 106 may alternatively be referred to as remote stations, access terminals, terminals, subscriber units, mobile stations, stations, user equipment and the like. User terminals 106 may be personal wireless devices, such as cellular phones, personal digital assistants (PDAs), handheld devices, wireless modems, audio/video players, laptop computers, personal computers, other handheld communication devices, other handheld computing devices, satellite radios, global positioning systems, and so on. A variety of algorithms and methods may be used for transmissions in wireless communication system 100 between base stations 104 and user terminals 106. For example, signals may be sent and received between base stations 104 and user terminals 106 in accordance with OFDM/OFDMA techniques. If this is the case, wireless communication system 100 may be referred to as an OFDM/OFDMA system 100.

A communication link that facilitates transmission from base station 104 to user terminal 106 may be referred to as a downlink 108, and a communication link that facilitates transmission from user terminal 106 to base station 104 may be referred to as an uplink 110. Alternatively, downlink 108 may be referred to as a forward link or a forward channel, and uplink 110 may be referred to as a reverse link or a reverse channel. Cell 102 may be divided into multiple sectors 112. Sector 112 is a physical coverage area within cell 102. Base stations 104 within an OFDM/OFDMA system 100 may utilize antennas that concentrate the flow of power within a particular sector 112 of the cell 102. Such antennas may be referred to as directional antennas.

In certain embodiments, system 100 can be a multiple-input multiple-output (MIMO) communication system. Further, system 100 can utilize substantially any type of duplex technique to divide communication channels (e.g., forward link 108, reverse link 110, etc.) such as FDD, TDD, and the like. The channels can be provided for transmitting control data between mobile devices 106 and respective base stations 104.

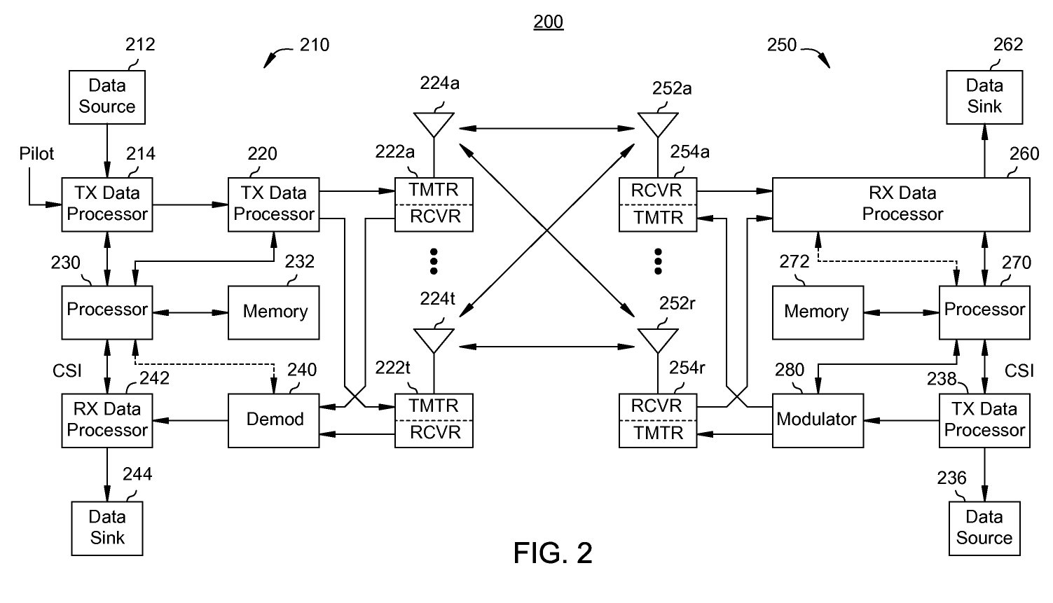

FIG. 2 illustrates an exemplary wireless network environment 200 in accordance with certain embodiments set forth herein. Wireless network environment 200 depicts one base station 210 and one mobile device 250 for sake of brevity. However, it is contemplated that system 200 can include one or more base stations and/or one or more mobile devices, wherein additional base stations and/or mobile devices can be substantially similar or different from illustrated base station 210 and illustrated mobile device 250 described herein. In addition, it is contemplated that base station 210 and/or mobile device 250 can employ the systems, techniques, configurations, embodiments, aspects, and/or methods described herein to facilitate wireless communication between them.

At base station 210, traffic data for a number of data streams is provided from a data source 212 to transmit (TX) data processor 214. In certain embodiments, each data stream can be transmitted over a respective antenna and/or over multiple antennas. TX data processor 214 formats, codes, and interleaves the traffic data stream based on a particular coding scheme selected for that data stream to provide coded data.

The coded data for each data stream can, for example, be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 250 to estimate channel response or other communication parameters and/or characteristics. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 230.

The modulation symbols for the data streams can be provided to a TX MIMO processor 220, which can further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies certain multi-antenna techniques, such spatial multiplexing, diversity coding or precoding (i.e., beamforming, with weights being applied to the modulation symbols of the data streams and to the antenna from which the symbol is being transmitted).

Each transmitter 222 receives and processes a respective modulation symbol stream to provide one or more analog signals, and further conditions (e.g., amplifies, filters, upconverts, etc.) the analog signals to provide a modulated signal suitable for transmission over the MIMO channel. Further, N_{T} modulated signals from transmitters 222a through 222t are transmitted from N_{T} antennas 224a through 224t, respectively.

At mobile device 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, downconverts, etc.) a respective signal, digitizes the conditioned signal to provide samples, and further processes the samples to provide a corresponding “received” symbol stream.

A receive (RX) data processor 260 can receive and process the N_{R} received symbol streams from N_{R} receivers 254 based on a particular receiver processing technique to provide N_{T} “detected” symbol streams. RX data processor 260 can demodulate, deinterleave, decode, and etc. each detected symbol stream to recover the traffic data for the data stream, and provide the traffic data to a data sink 262. In certain embodiments, for mobile device 250, the processing by RX data processor 260 can be complementary to that performed by TX MIMO processor 220 and TX data processor 214 at base station 210.

A processor 270 can periodically determine which precoding matrix to utilize as discussed above. Further, processor 270 can formulate a reverse link message comprising a matrix index portion and a rank value portion. The reverse link message can comprise various types of information regarding the communication link and/or the received data stream. The reverse link message can be processed by a TX data processor 238, which also receives traffic data for a number of data streams from a data source 236, modulated by a modulator 280, conditioned by transmitters 254a through 254r, and transmitted back to base station 210.

At base station 210, the modulated signals from mobile device 250 are received by N_{R} antennas 224, conditioned by respective N_{R} receivers 222, demodulated by a demodulator 240, and processed by a RX data processor 242 to extract the reverse link message transmitted by mobile device 250, and provide the reverse link message to a data sink 244. Further, processor 230 can process the extracted message to determine which precoding matrix to use for determining the beamforming weights.

Processors 230 and 270 can direct (e.g., control, coordinate, manage, etc.) operation at base station 210 and mobile device 250, respectively. Respective processors 230 and 270 can be associated with memory 232 and 272 that store program codes and data. Processors 230 and 270 can also perform computations to derive frequency and impulse response estimates for the uplink and downlink, respectively. All “processor” functions can be migrated between and among process modules such that certain processor modules may not be present in certain embodiments, or additional processor modules not illustrated herein may be present.

Memory 232 and 272 (as with all data stores disclosed herein) can be either volatile memory or nonvolatile memory or can include both volatile and nonvolatile portions, and can be fixed, removable or include both fixed and removable portions. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink™ DRAM (SLDRAM), and direct Rambus™ RAM (DRRAM). Memory 308 of the certain embodiments is intended to comprise, without being limited to, these and any other suitable types of memory.

### Exemplary MIMO-OFDM System Model

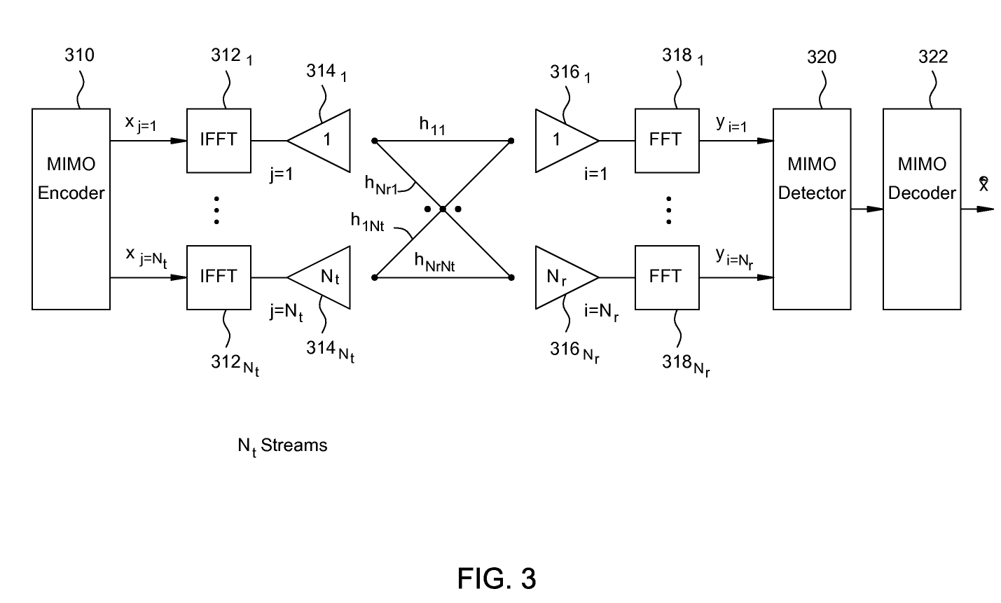

FIG. 3 shows a block diagram of generic multiple-input multiple-output (MIMO) OFDM wireless communication system with N_{T} transmit and N_{R} receive antennas. The system model for the k^{th} sub-carrier (frequency sub-channel) may be represented with linear equation:

yₖ=Hₖxₖ+nₖ, k=1, 2, . . . , N_{FFT}, (1)

where N_{FFT} is the number of orthogonal sub-carriers (frequency bins) in MIMO-OFDM system.

In equations and accompanying disclosure below, the sub-carrier index k is omitted for simplicity. Therefore, the system model can be re-written in the simple notation as:

$$\begin{matrix}y = Hx + n , & ( 2 ) \\ y = {[ {y}_{1} {y}_{2} … {y}_{{N}_{R}} ]}^{T} , & ( 3 ) \\ H = [ {h}_{1} {h}_{2} … {h}_{{N}_{T}} ] = [ \begin{matrix}{h}_{11} & {h}_{12} & … & {h}_{1 {N}_{T}} \\ & … & … & \\ {h}_{{N}_{R} 1} & {h}_{{N}_{R} 2} & … & {h}_{{N}_{R} {N}_{T}}\end{matrix} ] , & ( 4 ) \\ x = {[ {x}_{1} {x}_{2} … {x}_{{N}_{T}} ]}^{T} , & ( 5 )\end{matrix}$$

where y is [N_{R}×1] received symbol vector, H is [N_{R}×N_{T}] channel matrix and hⱼ is its j^{th} column vector that contains channel gains between the transmit antenna j and all N_{R} receive antennas, x is [N_{T}×1] transmitted symbol vector, n is [N_{R}×1] complex noise vector with covariance matrix E(nn^{H}).

Column vector hⱼ corresponds to the j^{th} spatial data stream transmitted from the j^{th} antenna. This column vector represents j^{th} spatial sub-channel that can be defined as a channel between j^{th} transmit antenna and all receive antennas, and may incorporate a plurality of channel gains between the transmit antenna j and all N_{R} receive antennas. Spatial sub-channels (or, equivalently, transmission channels) of the MIMO wireless system are mutually orthogonal during the transmission period if:

hᵢ^{H}·hⱼ=0∀i,j, such that i≠j (7)

As illustrated in FIG. 3, the transmission signal may be first encoded by MIMO channel encoder 310. A redundancy may be therefore included to protect information data during the transmission over noisy wireless channels. An encoded signal may then be split into N_{T} spatial data streams x₁, x₂, . . . , X_{N}_{_{T}}, as shown in FIG. 3. A plurality of spatial data streams can be converted into a time domain by utilizing Inverse Fast Fourier Transform (IFFT) units 312₁, . . . , 312_{N}_{_{T}} The signal may then be up converted to a desired transmission frequency band and transmitted from N_{T} transmit antennas 314₁, . . . 314_{N}_{_{T}} over N_{R}·N_{T} single-input single-output (SISO) channels.

N_{R} receive antennas 316₁, . . . , 316_{N}_{_{R}} are employed at the receiver. Received data streams can be converted back into a frequency domain by using the Fast Fourier Transform (FFT) units 318₁, . . . , 318_{N}_{_{R}}. A frequency domain signal may be input into a MIMO detector 320 that generates reliability messages for coded bits transmitted over a plurality of spatial sub-channels. A reliability message represents a probability that the particular transmitted coded bit is either bit “0” or bit “1.” This information can be passed to the outer MIMO channel decoder 322, and the estimated information data \hat{x} for a plurality of spatial sub-channels (transmit antennas) are available after removing the redundancy included at the transmitter.

### Exemplary Space-Time Coding Signal Model

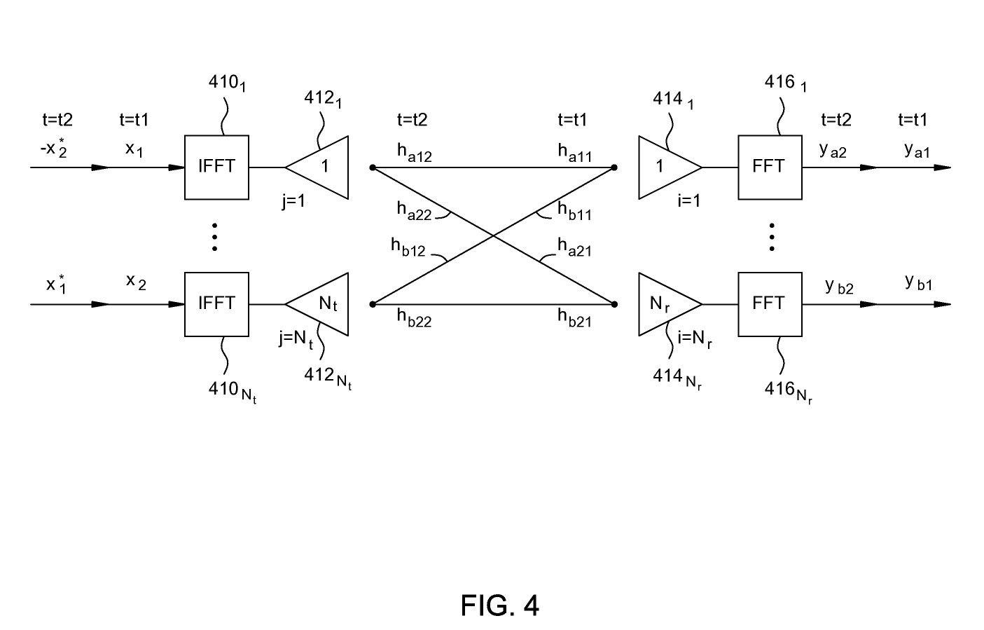

FIG. 4 illustrates space time coding (STC) system model in accordance with certain embodiments of the present disclosure. The STC system model from FIG. 4 can be also represented with linear equation (2).

The following notation may be used in the case of two consecutive transmission/reception time intervals and for an exemplary wireless system with two transmit and two receive antennas:

$$\begin{matrix}y = {[ {y}_{a 1} {y}_{a 2}^{*} {y}_{b 1} {y}_{b 2}^{*} ]}^{T} & ( 8 ) \\ H = [ \begin{matrix}{h}_{a 11} & {h}_{b 11} \\ {h}_{b 12}^{*} & - {h}_{a 12}^{*} \\ {h}_{a 21} & {h}_{b 21} \\ {h}_{b 22}^{*} & - {h}_{a 22}^{*}\end{matrix} ] & ( 9 ) \\ x = {[ {x}_{1} {x}_{2} ]}^{T} & ( 10 ) \\ n = {[ {n}_{1} {n}_{2} {n}_{3} {n}_{4} ]}^{T} & ( 11 )\end{matrix}$$

where xₙ is the n^{th} transmit symbol; the channel coefficient hⱼᵢₜ corresponds to the transmit antenna 412ⱼ, receive antenna 414ᵢ and the transmit time interval “t;” received signal yₘₜ corresponds to the receive antenna 414ₘ and the receive time interval “t.” FIG. 4 illustrates two consecutive time intervals for transmission/reception: t=t₁ and t=t₂.

It can be observed from FIG. 4 that during the second transmission time interval t₂ the conjugate value of the signal transmitted during the first time interval t₁ from antenna 412₁ may be transmitted from antenna 412_{N}_{_{T}} (if N_{T}=2). Also negative conjugate value of the signal transmitted in the first time interval t₁ from antenna 412_{N}_{_{T}} (if N_{T}=2) may be transmitted from antenna 412₁ during the second transmission time interval t₂.

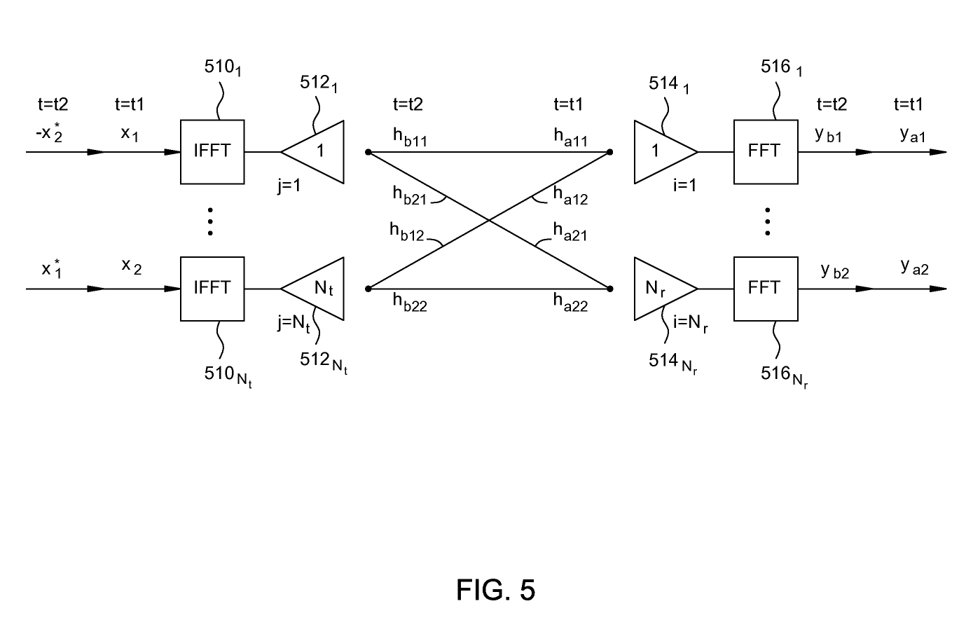

FIG. 5 illustrates another exemplary STC system model in accordance with certain embodiments of the present disclosure. The following notation may be utilized in the case of two consecutive time intervals for transmission/reception and for a wireless system with two transmit and two receive antennas:

$$\begin{matrix}y = {[ {y}_{a 1} {y}_{b 1}^{*} {y}_{a 2} {y}_{b 2}^{*} ]}^{T} & ( 12 ) \\ H = [ \begin{matrix}{h}_{a 11} & {h}_{a 12} \\ {h}_{b 12}^{*} & - {h}_{b 11}^{*} \\ {h}_{a 21 } & {h}_{a 22} \\ {h}_{b 22}^{*} & - {h}_{b 21}^{*}\end{matrix} ] & ( 13 )\end{matrix}$$

The transmitted signal vector x can be represented in the same way as in equation (10), while the vector of receiver noise for two consecutive time intervals may be represented in the same way as in equation (11).

Channel coefficient hₜᵢⱼ in FIG. 5 may correspond to the transmit time interval “t,” receive antenna 514ᵢ and transmit antenna 512ⱼ. The received signal yₜᵢ may correspond to the receive time interval “t” and receive antenna 514ᵢ. FIG. 5 illustrates two consecutive time intervals for transmission and reception: t=t₁ and t=t₂. The same space time coding scheme applied for the exemplary system model illustrated in FIG. 4 may be also assumed for the exemplary system model illustrated in FIG. 5.

Exemplary Maximum Ration Combining based STC Signal Decoding

In order to decode the STC signal, maximum-ratio combining (MRC) based STC decoding may be utilized at the receiver. The MRC space-time decoding may be represented as:

\tilde{x}=H^{H}y (14)

where H^{H} is Hermitian (conjugate-transpose) version of the channel matrix, and \tilde{x} is decoded symbol vector that represents MRC estimate of transmitted symbol vector x.

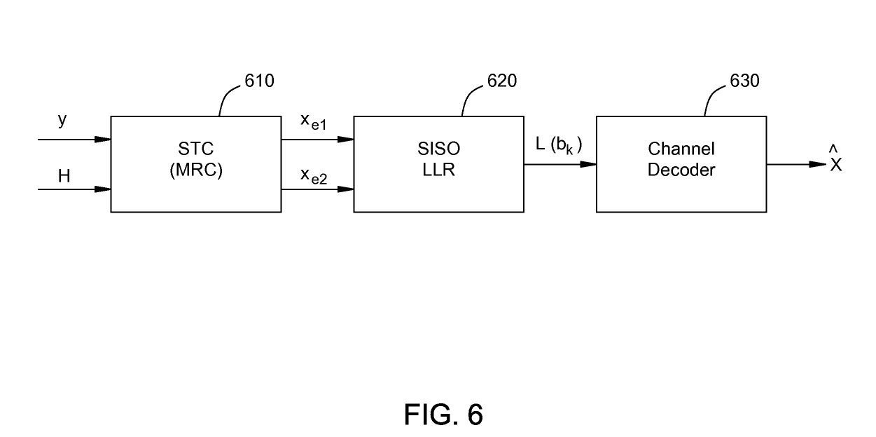

FIG. 6 illustrates an example block diagram of conventional MRC based STC signal decoder. For an illustrative example of two transmit antennas, symbols xₑ₁ and xₑ₂ may be obtained after applying expression (14) by unit 610. These symbols represent MRC estimates transmitted during the STC symbol duration interval from the first and second antenna, respectively. These MRC symbol estimates may be then utilized by unit 620 to calculate log-likelihood ratios (LLRs) for transmitted coded bits. Unit 620 represents a single-input single-output (SISO) unit as illustrated in FIG. 6 because a single estimate of transmitted modulated symbol may be utilized to compute LLRs for corresponding coded bits. Outer MIMO channel decoder 630 may use calculated LLRs to decode transmitted information bits.

The MRC based STC decoding algorithm is not overly computationally complex, and provides excellent error rate performance if spatial sub-channels (i.e., channels between a single transmit and all receive antennas) are mutually orthogonal during the STC symbol duration as defined by equation (7). However, in certain cases spatial sub-channels may not be orthogonal, such as in the case of high Doppler frequency (high mobility of active users), imperfect frequency and timing synchronization between transmitter and receiver, long delay spread of MIMO wireless channel, high-order modulation type applied at the transmitter, etc. Therefore, for certain channel conditions the MRC based decoding scheme may cause error rate performance degradation, and more sophisticated decoding algorithm may need to be applied at the receiver.

### Exemplary MIMO-Based STC Signal Decoding

If spatial sub-channels are not orthogonal, the STC decoding based on Minimum Mean Square Error (MMSE) or maximum-likelihood (ML) algorithms is proposed in this disclosure in order to improve error rate performance of conventional MRC decoding. However, computational complexity of both MMSE and ML algorithms are significantly higher than that of MRC algorithm. Selective STC decoder is proposed in this disclosure that incorporates both MRC decoding and MIMO based decoding (i.e., MMSE or ML decoding). The appropriate STC decoding algorithm may then be selected based on channel environment in which transmitter and receiver operate.

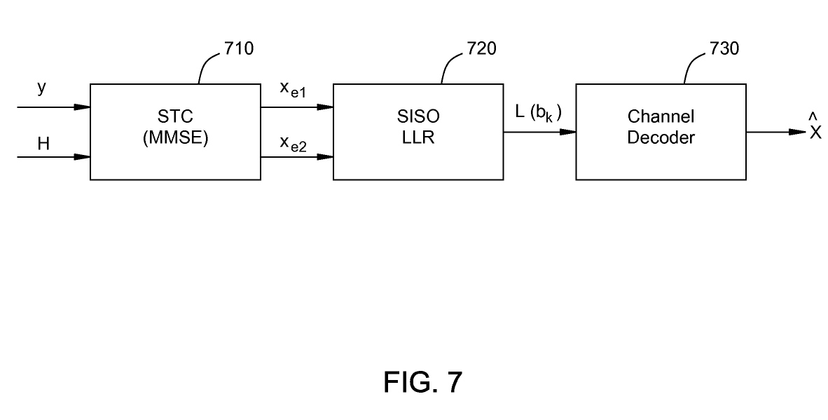

FIG. 7 illustrates an example block diagram of proposed MMSE based STC signal decoder. The MMSE decoder 710 may be designed to decode transmitted signal generated with spatial multiplexing (SM), which assumes that independent data streams may be generated for each transmit antenna.

Considering the STC signal model represented either by equations (8)-(11) or by equations (12)-(13) for an exemplary wireless system with two transmit and two receive antennas, it can be observed that the STC signal may be represented as a spatially multiplexed signal in a wireless system of effective size 4 by 2 (i.e., wireless system with increased effective dimension at the receiver). As shown in equation (9) and equation (13), the size of effective channel matrix is ((N_{R}+N_{T})×N_{T}), which corresponds to a wireless system with (N_{R}+N_{T}) effective receive antennas instead of N_{R} physical antennas.

Because of increased effective dimension at the receiver, the STC signal may be successfully decoded by utilizing the MMSE channel equalizer represented as:

\tilde{x}=(H^{H}H+σₙ²I)⁻¹H^{H}y, (15)

where H is the effective channel matrix from equation (9) or equation (13) of size ((N_{R}+N_{T})×N_{T}), σₙ² is the noise variance of transmission channels, and I represents identity matrix of size [N_{T}×N_{T}]. By applying the MMSE detection based spatial multiplexing at the transmitter with increased number of effective receive antennas, it can be expected to achieve improved error rate performance compared to the MRC detection, especially if spatial sub-channels are not orthogonal during the STC symbol duration as defined by equation (7).

Symbol estimates obtained after applying equation (15) may then be utilized in unit 720 to calculate LLRs for transmitted coded bits. Unit 720 also represents a single-input single-output (SISO) unit as illustrated in FIG. 7 because a single estimate of transmitted modulated symbol may be utilized to compute LLRs for corresponding transmitted coded bits. Outer channel decoder 730 may employ LLRs to provide decoded information bits \hat{x}.

The maximum likelihood based MIMO detector is also proposed in this disclosure that may be used for decoding of STC signals. The Gaussian probability density function may be associated with the transmission symbol vector x. In this case, the LLR for the k^{th} bit of transmission signal vector x L(bₖ) may be computed as:

$$\begin{matrix}L ( {b}_{k} ) = LLR ( {b}_{k} \vert y ) \\ = log [ \frac{{\sum }_{x \text{:} {b}_{k} = 0}^{ } p ( y \vert x )}{{\sum }_{x \text{:} {b}_{k} = 1}^{ } p ( y \vert x )} ] \\ \approx log [ \frac{{max}_{x \text{:} {b}_{k} = 0} p ( y \vert x )}{{max}_{x \text{:} {b}_{k} = 1} p ( y \vert x )} ] \\ = log [ \frac{{max}_{x \text{:} {b}_{k} = 0} exp ( - d ( x ) )}{{max}_{x \text{:} {b}_{k} = 1} exp ( - d ( x ) )} ] \\ = {min}_{x \text{:} {b}_{k} = 1} d ( x ) - {min}_{x \text{:} {b}_{k} = 0} d ( x )\end{matrix} \qquad ( 16 )$$

where expression “x: bₖ=0” denotes a set of candidate transmission bits x with the k^{th} information bit equal to “0”, expression “x: bₖ=1” denotes a set of candidate transmission bits x with the k^{th} information bit equal to “1,” p(x) is a probability density function of hypothesis x, and it is assumed that all hypotheses x are equally distributed. The metric d(x) may be given as:

$$\begin{matrix}d ( x ) = d ( {x}_{1} , … {x}_{j } … , {x}_{{N}_{t}} ) \\ = \frac{{‖ y - Hx ‖}^{2}}{{σ}_{n}^{2}}\end{matrix} \qquad ( 17 )$$

where channel H represents effective channel matrix of size ((N_{R}+N_{T})×N_{T}), and the received signal vector y may be given by equation (8) or equation (12).

This approach is commonly referred to as the Max-Log-MAP ML detection algorithm. The Max-Log-MAP ML algorithm may achieve optimal detection accuracy because it evaluates likelihoods of all modulation symbols that may be transmitted, as shown by expression (16). However, the operational complexity of the Max-Log-MAP ML detection may be substantial. The complexity is proportional to O(M^{N}^{_{T}}), where M is the modulation order equal to 2^{B}, and B is the number of bits that may be utilized to represent a single M-QAM modulation symbol. As shown by equation (17), calculation of LLRs may be based on squared l₂² norms. Assuming unitary variance of effective noise at the receiver (after pre-whitening, for example), the c^{th} metric d_{c} from equation (16) and (17) may be represented as:

d_{c}=l₂²=∥v₂∥₂² (18)
where, v=y−Hx, c=1, 2, . . . , M^{N}^{ₜ}

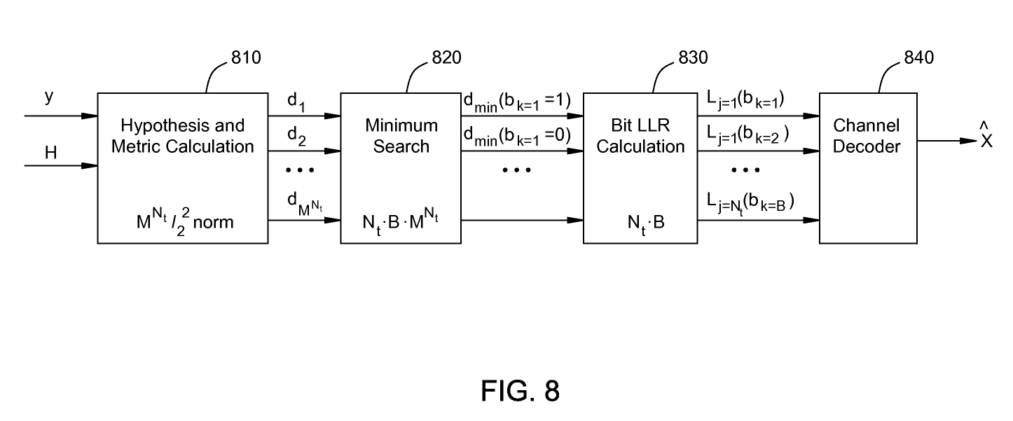

FIG. 8 shows a block diagram of typical implementation of Max-Log-MAP ML detection. All elements of the effective channel matrix H and received samples y may be provided as input into unit 810. All possible M^{N}^{_{T}} vector symbols x that may be transmitted from N_{T} antennas may be hypothesized. Consequently, M^{N}^{_{T}} squared l₂² norms may be calculated as specified by equation (18). Following that, unit 820 may perform search for minima metrics based on l₂² norms for every transmission bit k=1, 2, . . . , N_{T}·B for all hypotheses x for which bit k is equal to bit “0,” and for all hypotheses x for which bit k is equal to bit “1.” Therefore, the computational complexity of the search algorithm may be proportional to O(N_{T}·B·M^{N}^{_{T}}) .

Based on found minima metrics for every transmission bit k=1, 2, . . . , N_{T}·B, bit LLRs may be calculated in unit 830 based on equation (16). Calculated LLRs for all N_{T}·B coded bits transmitted over a plurality of spatial sub-channels for a single frequency sub-band may then be passed to the outer channel decoder 840 that generates decoded spatial data streams.

### Exemplary Selective STC Decoding

One particular advantage of the MRC based STC decoding may be its lower computational complexity compared to the MIMO based decoding (MMSE and ML decoding), which may lead to a lower dissipation of dynamic power. On the other side, the proposed MIMO based STC decoding schemes may provide better error rate performance than MRC algorithm when transmission spatial sub-channels are not mutually orthogonal during the STC symbol duration. In order to take advantage of both MRC and MIMO based decoding schemes, the selective STC decoding that incorporates both approaches may be implemented and it is proposed in this disclosure.

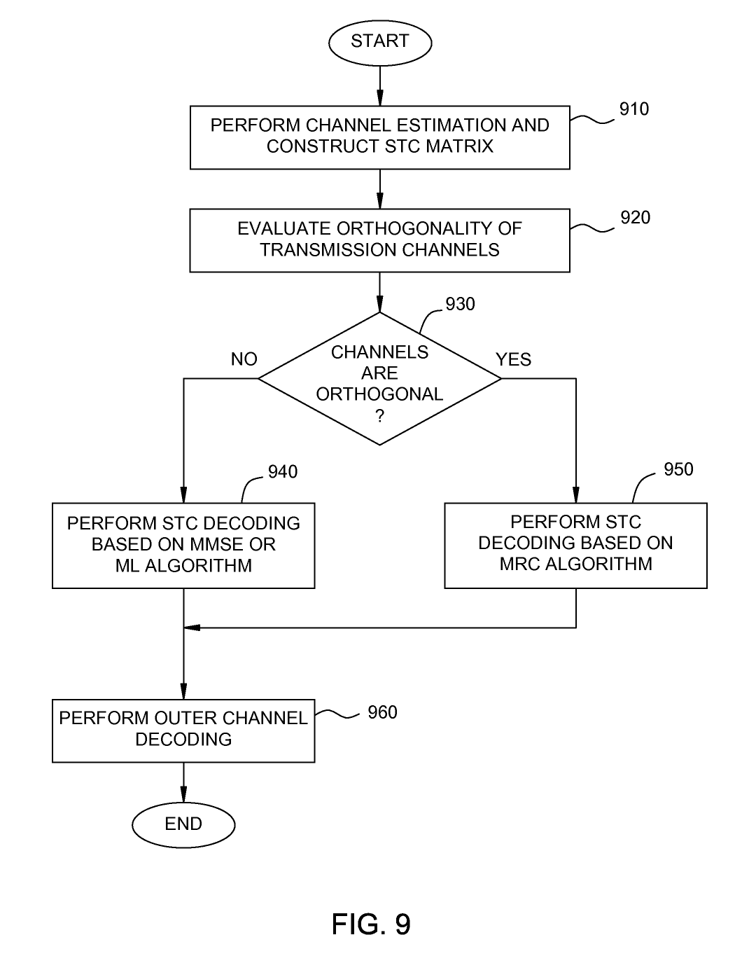

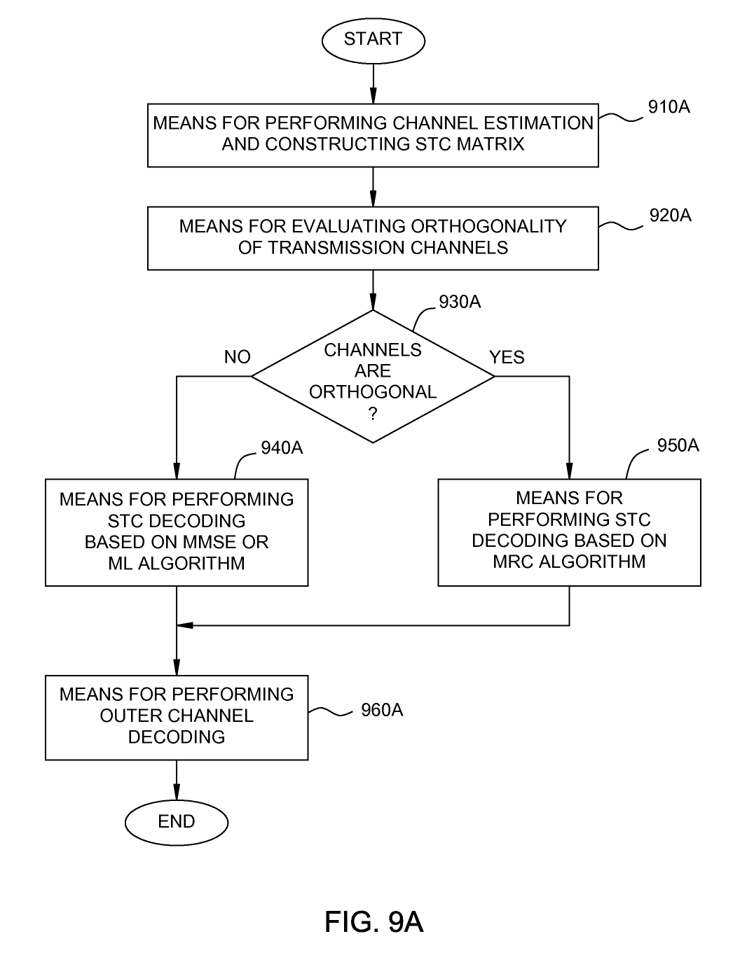

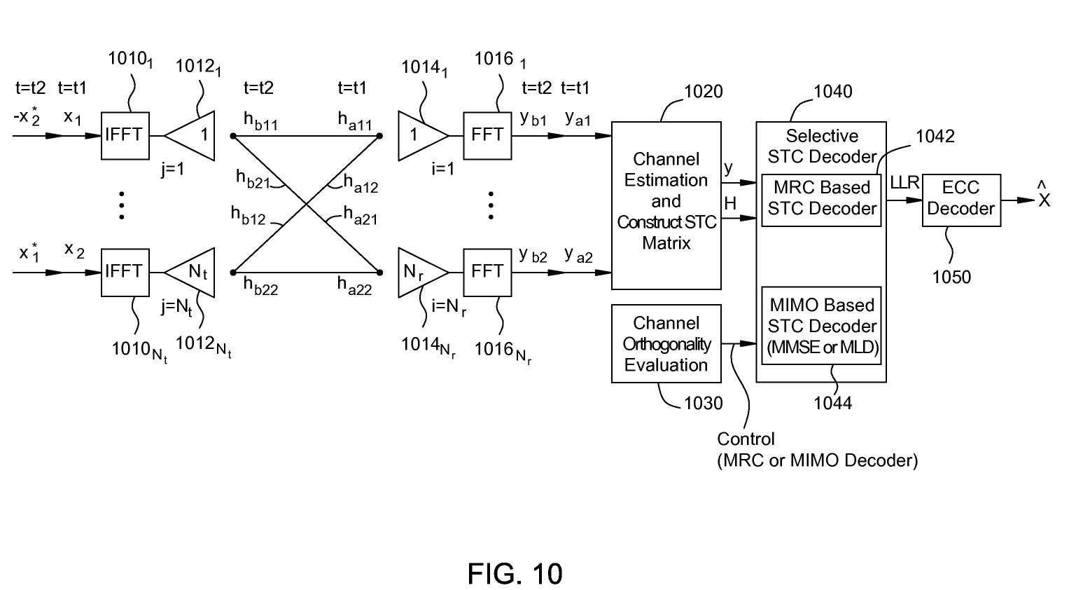

FIG. 9 shows a process of selective STC decoding, and FIG. 10 illustrates an example block diagram of selective STC decoder in accordance with certain embodiments of the present disclosure. At 910, the received pilot signal may be utilized to perform channel estimation. Once the channel coefficients are estimated, the effective STC channel matrix may be formed based on the employed space time coding scheme at the transmitter, as presented for an exemplary case of two transmit antennas with equations (9) and (13). This is also illustrated by unit 1020 in FIG. 10.

At 920, channel orthogonality has been evaluated by unit 1030 based on estimated Doppler frequency and applied modulation type at the transmitter. Based on estimated channel orthogonality, the appropriate STC decoding algorithm may be selected. At 930, the MRC based STC decoder 1042 may be chosen if transmission spatial sub-channels are mutually orthogonal during the STC symbol duration. This is usually true in channel environments have low Doppler conditions (low mobility of active users) and if low-order modulation types are applied at the transmitter. In this case, typically, there is no difference in error-rate performance between MRC and MIMO based STC decoding algorithms, but the dissipated dynamic power at the receiver may be significantly reduced if the MRC algorithm is selected.

If the spatial sub-channels are not orthogonal during the STC symbol duration, which is usual for channel environments with high Doppler frequency, as determined at 930, the MIMO based STC decoding algorithm may be selected. At 940, the MIMO STC decoding may be performed by unit 1042 based on either MMSE or ML algorithm. Alternatively, if the spatial sub-channels are mutually orthogonal, the STC decoding based on MRC may be performed, at 950, by unit 1044.

As illustrated in FIG. 10, decoding units 1042 and 1044 may be integral parts of the selective STC decoder unit 1040. When either one of these two decoding schemes is selected, the decoding unit that is not being selected (either unit 1042 or unit 1044) may be turned-off in order to prevent dissipation of dynamic power. By choosing the appropriate STC decoding algorithm, the trade-off between amount of dissipated dynamic power and error rate performance may be achieved.

Reliability information about transmitted coded bits may be available at the output of selective STC decoder 1040 in the form of log-likelihood ratios (LLRs). At 960, LLRs for transmitted coded bits may be passed to the outer MIMO channel decoder 1050 to decode transmitted information data.

### Exemplary Simulation Results

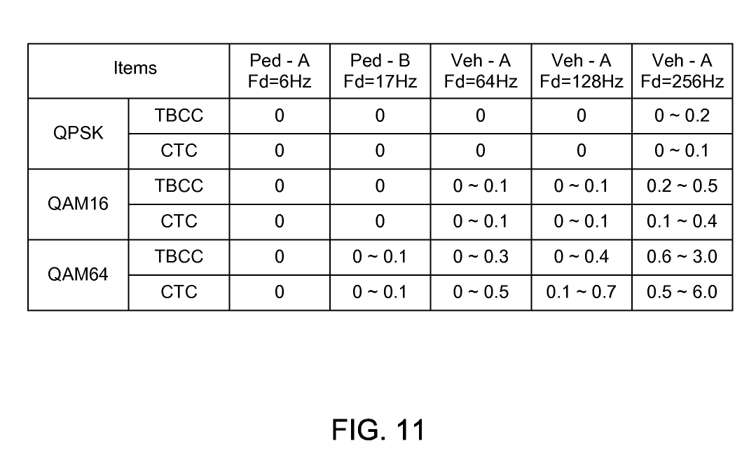

Exemplary simulations in the present disclosure are conducted to evaluate error rate performance of proposed STC detection schemes in channel environments with various Doppler effects and with different modulation types applied at the transmitter. FIG. 11 shows the ML/MMSE error rate performance gain in decibel (dB) units relative to the MRC based STC decoding at the packet error rate (PER) of 10⁻². It is assumed perfect synchronization and perfect channel state information at the receiver.

Three different modulation types may be utilized for different SNR range. QPSK modulation may be used for the SNR range between 2 dB and 14 dB, 16-QAM modulation may be used for the SNR range between 2 dB and 20 dB, and 64-QAM modulation may be used for the SNR range between 6 dB and 24 dB. A resolution step of 0.5 dB units for measuring the PER performance may be applied for all utilized modulation types. Two different coding schemes may be implemented in the exemplary simulations: tailbiting convolutional codes (TBCC) with code rates of ½, ⅔, and ¾, and convolution Turbo codes (CTC) with code rates of ½, ⅔, ¾, and ⅚. 10000 coding blocks may be used in the exemplary simulations. As shown in FIG. 11, different fading scenarios may be evaluated with different velocities of mobile users (different Doppler frequencies). The carrier frequency of 2.3 GHz may be used, and an exemplary wireless system with two transmit and two receive antennas may be considered.

The ML detection may also incorporate preprocessing based on QR decomposition in order to decrease the number of transmission hypotheses. This is QRML detection that is well known in the art. Both MMSE and QRML detection algorithms may model MIMO wireless channel as an effective (N_{R}+N_{T})×N_{T}=4×2 channel, since the effective dimension at the receiver is increased from N_{R} to (N_{R}+N_{T}) because of spatial and temporal redundancy (space-time coding) applied at the transmitter.

Simulation results are summarized in FIG. 11 showing relative gain of the proposed MIMO based STC decoder (i.e., MMSE or ML decoder) compared to the conventional MRC based STC decoder. For low Doppler conditions and for low-order modulation types (for example, pedestrian channels with QPSK modulation), MRC, QRML and MMSE algorithms show almost identical PER performance. In channel environments with high Doppler conditions and for high order modulation types, the QRML and MMSE algorithms may provide identical PER performance and MRC decoding may experience error rate performance degradation between 0.1 dB and 6 dB at PER equal to 10⁻² compared to QRML and MMSE algorithms. When the spatial sub-channels are not mutually orthogonal during the STC symbol duration then the QRML/MMSE solution may be selected at the receiver in order to achieve excellent decoding accuracy, although the power dissipation may increase compare to the MRC decoding.

The various operations of methods described above may be performed by various hardware and/or software component(s) and/or module(s) corresponding to means-plus-function blocks illustrated in the Figures. For example, blocks 910-960 illustrated in FIG. 9 correspond to means-plus-function blocks 910A-960A illustrated in FIG. 9A. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for decoding data transmitted in a wireless multi-channel communications system using a space time coding (STC) scheme, comprising:
receiving STC signals transmitted over multiple channels utilizing an STC scheme;
modeling the STC signals as if transmitted as spatially multiplexed multiple-input multiple-output (MIMO) signals; and
decoding the first sequence of received signals using a MIMO decoding scheme.

2. The method of claim 1, wherein the MIMO decoding scheme does not assume the multiple channels are orthogonal.

3. The method of claim 1, wherein modeling the first sequence of signals as if transmitted as spatially multiplexed multiple-input multiple-output (MIMO) signals comprises:
modeling the STC signals as if transmitted as spatially multiplexed MIMO signals on a larger number of channels than actually used to transmit the STC signals.

4. The method of claim 1, wherein the MIMO decoding scheme comprises a minimum mean squared error (MMSE)-based decoding scheme.

5. The method of claim 1, wherein the MIMO decoding scheme comprises a maximum likelihood (ML)-based MIMO decoding scheme.

6. A method for wireless communication comprising:
selecting between a multiple-input, multiple-output (MIMO) decoder and a maximum ration combining (MRC) decoder for decoding a space-time coded (STC) signal, based at least on one or more parameters; and
decoding the STC signal using the selected decoder.

7. The method of claim 6, wherein the one or more parameters comprise at least one of: Doppler frequency and modulation type.

8. The method of claim 6, wherein the MIMO decoder is a 4 by 2 spatial multiplexing MIMO decoder.

9. The method of claim 6, wherein the MIMO decoder comprises a minimum mean squared error (MMSE)-based MIMO decoder.

10. The method of claim 6, wherein the MIMO decoder comprises a maximum likelihood (ML)-based MIMO decoder.

11. The method of claim 6, further comprising:
powering down components of the decoder that is not selected.

12. An apparatus for decoding data transmitted in a wireless multi-channel communications system using a space time coding (STC) scheme, comprising:
logic for receiving STC signals transmitted over multiple channels utilizing an STC scheme;
logic for modeling the STC signals as if transmitted as spatially multiplexed multiple-input multiple-output (MIMO) signals; and
logic for decoding the first sequence of received signals using a MIMO decoding scheme.

13. The apparatus of claim 12, wherein the logic for decoding the first sequence of received signals using a MIMO decoding scheme does not assume the multiple channels are orthogonal.

14. The apparatus of claim 12, wherein the logic for modeling the STC signals as if transmitted as spatially multiplexed MIMO signals is configured to:
model the STC signals as if transmitted as spatially multiplexed MIMO signals on a larger number of channels than actually used to transmit the STC signals.

15. The apparatus of claim 12, wherein the logic for decoding the first sequence of received signals using a MIMO decoding scheme is configured to perform a minimum mean squared error (MMSE)-based decoding scheme.

16. The apparatus of claim 12, wherein the logic for decoding the first sequence of received signals using a MIMO decoding scheme is configured to perform a maximum likelihood (ML)-based MIMO decoding scheme.

17. An apparatus for wireless communication comprising:
logic for selecting between a multiple-input, multiple-output (MIMO) decoder and a maximum ration combining (MRC) decoder for decoding a space-time coded (STC) signal, based at least on one or more parameters; and
logic for decoding the STC signal using the selected decoder.

18. The apparatus of claim 17, wherein the one or more parameters comprise at least one of: Doppler frequency and modulation type.

19. The apparatus of claim 17, wherein the MIMO decoder is a 4 by 2 spatial multiplexing MIMO decoder.

20. The apparatus of claim 17, wherein the MIMO decoder comprises a minimum mean squared error (MMSE)-based MIMO decoder.

21. The apparatus of claim 17, wherein the MIMO decoder comprises a maximum likelihood (ML)-based MIMO decoder.

22. The apparatus of claim 17, further comprising:
logic for powering down components of the decoder that is not selected.

23. An apparatus for decoding data transmitted in a wireless multi-channel communications system using a space time coding (STC) scheme, comprising:
means for receiving STC signals transmitted over multiple channels utilizing an STC scheme;
means for modeling the STC signals as if transmitted as spatially multiplexed multiple-input multiple-output (MIMO) signals; and
means for decoding the first sequence of received signals using a MIMO decoding scheme.

24. The apparatus of claim 23, wherein the means for decoding the first sequence of received signals using a MIMO decoding scheme is configured to do not assume the multiple channels are orthogonal.

25. The apparatus of claim 23, wherein the means for modeling STC signals as if transmitted as spatially multiplexed multiple-input multiple-output (MIMO) signals is configured to:
model the STC signals as if transmitted as spatially multiplexed MIMO signals on a larger number of channels than actually used to transmit the STC signals.

26. The apparatus of claim 23, wherein the means for decoding the first sequence of received signals using a MIMO decoding scheme is configured to perform a minimum mean squared error (MMSE)-based decoding scheme.

27. The apparatus of claim 23, wherein the means for decoding the first sequence of received signals using a MIMO decoding scheme is configured to perform a maximum likelihood (ML)-based MIMO decoding scheme.

28. An apparatus for wireless communication comprising:
means for selecting between a multiple-input, multiple-output (MIMO) decoder and a maximum ration combining (MRC) decoder for decoding a space-time coded (STC) signal, based at least on one or more parameters; and
means for decoding the STC signal using the selected decoder.

29. The apparatus of claim 28, wherein the one or more parameters comprise at least one of: Doppler frequency and modulation type.

30. The apparatus of claim 28, wherein the MIMO decoder is a 4 by 2 spatial multiplexing MIMO decoder.

31. The apparatus of claim 28, wherein the MIMO decoder comprises a minimum mean squared error (MMSE)-based MIMO decoder.

32. The apparatus of claim 28, wherein the MIMO decoder comprises a maximum likelihood (ML)-based MIMO decoder.

33. The apparatus of claim 28, further comprising:
means for powering down components of the decoder that is not selected.

34. A computer-program product for decoding data transmitted in a wireless multi-channel communications system using a space time coding (STC) scheme, comprising a computer readable medium having instructions stored thereon, the instructions being executable by one or more processors and the instructions comprising:
instructions for receiving STC signals transmitted over multiple channels utilizing an STC scheme;
instructions for modeling the STC signals as if transmitted as spatially multiplexed multiple-input multiple-output (MIMO) signals; and
instructions for decoding the first sequence of received signals using a MIMO decoding scheme.

35. The computer-program product of claim 34, wherein the instructions for decoding the first sequence of received signals using a MIMO decoding scheme do not assume the multiple channels are orthogonal.

36. The computer-program product of claim 34, wherein the instructions for modeling the STC signals as if transmitted as spatially multiplexed multiple-input multiple-output (MIMO) signals comprise:
instructions for modeling the STC signals as if transmitted as spatially multiplexed MIMO signals on a larger number of channels than actually used to transmit the STC signals.

37. The computer-program product of claim 34, wherein the instructions for decoding the first sequence of received signals using a MIMO decoding scheme comprise instructions for performing a minimum mean squared error (MMSE)-based decoding scheme.

38. The computer-program product of claim 34, wherein the instructions for decoding the first sequence of received signals using a MIMO decoding scheme comprise instructions for performing a maximum likelihood (ML)-based MIMO decoding scheme.

39. A computer-program product for wireless communication, comprising a computer readable medium having instructions stored thereon, the instructions being executable by one or more processors and the instructions comprising:
instructions for selecting between a multiple-input, multiple-output (MIMO) decoder and a maximum ration combining (MRC) decoder for decoding a space-time coded (STC) signal, based at least on one or more parameters; and
instructions for decoding the STC signal using the selected decoder.

40. The computer-program product of claim 39, wherein the one or more parameters comprise at least one of: Doppler frequency and modulation type.

41. The computer-program product of claim 39, wherein the MIMO decoder is a 4 by 2 spatial multiplexing MIMO decoder.

42. The computer-program product of claim 39, wherein the MIMO decoder comprises a minimum mean squared error (MMSE)-based MIMO decoder.

43. The computer-program product of claim 39, wherein the MIMO decoder comprises a maximum likelihood (ML)-based MIMO decoder.

44. The computer-program product of claim 39, wherein the instructions further comprise:
instructions for powering down components of the decoder that is not selected.
